(19) United States
(12) Patent Application Publication
(10) Pub. No.: US 2006/0193398 A1
(43) Pub. Date: Aug. 31, 2006

(54) Data retransmission method employing symbol rearrangement over the galois field

(76) Inventors: Alexander Golitschek Edler Von Elbwart, Darmstadt (DE); Christian Wengerter, Kleinheubach (DE)

Correspondence Address: STEVENS, DAVIS, MILLER & MOSHER, LLP, 1615 L. STREET N.W., SUITE 850, WASHINGTON, DC, 20036, US

(21) Appl. No.: 10/538,842

(22) PCT Filed: Dec. 23, 2002
(86) PCT No.: PCT/EP02/14745

§ 371 Date: Jan. 25, 2006

(51) Int. Cl. H04L 27/20

(52) U.S. Cl. 375/308

(57) ABSTRACT

A method for transmitting data from a transmitter to a receiver of an ARQ communication system comprising the step of encoding data received from a signal source using a forward error correction (FEC) code to generate Galois field (GF) symbols. Further, it comprises the steps of mapping the GF symbols using quadrature phase shift keying (QPSK) as modulation scheme transmitting the QPSK modulation symbols to the receiver. The invention further relates to corresponding transmitter, receiver and communication system.

The present invention relates to a method for data transmission employing Galois Field (GF) symbols with transmission symbol rearrangement as set forth in independent claim 1. The invention also relates to a corresponding transmitter, receiver and ARQ communication system as defined by the other independent claims.

This invention generally concerns the packet-oriented transmission of data in a communication system. It comprises ARQ functionality, FEC coding, digital QPSK modulation, GF(4) arithmetics and the principle of error decoding by euclidean distances in the signal space.

A common technique for error detection of non-real time services is based on Automatic Repeat reQuest (ARQ) schemes together with Forward Error Correction (FEC), called Hybrid ARQ (HARQ). If an error is detected by the Cyclic Redundancy Check (CRC), the receiver requests the transmitter to send additional bits.

It has been shown in S. Kallel, Analysis of a type II hybrid ARQ scheme with code combining, IEEE Transactions on Communications, Vol. 38, No. 8, August 1990; S. Kallel, R. Link, S. Bakhtiyari, Throughput performance of Memory ARQ schemes, IEEE Transactions on Vehicular Technology, Vol. 48, No. 3, May 1999; and B. A. Harvey and S. Wicker, Packet Combining Systems based on the Viterbi Decoder, IEEE Transactions on Communications, Vol. 42, No. 2/3/4, April 1994, that the performance of a communication system can be improved when ARQ is combined with FEC, and furthermore if the ARQ retransmissions are combined at the receiver. Additionally the concept of constellation rearrangement has proven to enhance the system's performance by rearranging the modulation symbol mapping if additional ARQ retransmissions are necessary as disclosed for example in WO 02/067491 A1

A packet will be encoded with the FEC before transmission. Depending on the bits that are retransmitted three different types of ARQ are defined.
Type I: The erroneous received packets are discarded and a new copy of the same packet is retransmitted and decoded separately. There is no combining of earlier and later received versions of that packet.
Type II: The erroneous received packets are not discarded, but are combined with some incremental redundancy bits provided by the transmitter for subsequent decoding. Retransmitted packets sometimes have higher coding rates and are combined at the receiver with the stored values. That means that only little redundancy is added in each retransmission.
Type III: Is the same as Type II with the constraint each retransmitted packet is now self-decodable. This implies that the transmitted packet is decodable without the combination with previous packets. This is useful if some packets are damaged in such a way that almost no information is reusable.

Hybrid ARQ schemes II and III are obviously more intelligent and show a performance gain with respect to Type I, because they provide the ability to reuse information from of previously received erroneous packets. There exist basically three schemes of reusing the redundancy of previously transmitted packets:
Soft-Combining
Code-Combining
Combination of Soft- and Code-Combining

Employing soft-combining the retransmission packets carry identical symbols. In this case the multiple received packets are combined either by a symbol-by-symbol or by a bit-by-bit basis (D. Chase, Code combining: A maximum-likelihood decoding approach for combining an arbitrary number of noisy packets, IEEE Trans. Commun., Vol. COM-33, pp. 385-393, May 1985; and B. A. Harvey and S. Wicker, Packet Combining Systems based on the Viterbi Decoder, IEEE Transactions on Communications, Vol. 42, No. 2/3/4, April 1994). By combining these soft-decision values from all received packets the reliabilities of the transmitted bits will increase linearly with the number and power of received packets. From a decoder point of view the same FEC scheme (with constant code rate) will be employed over all transmissions. Hence, the decoder does not need to know how many retransmissions have been performed, since it sees only the combined soft-decision values. In this scheme all transmitted packets will have to carry the same number of symbols.

Code-combining concatenates the received packets in order to generate a new code word (decreasing code rate with increasing number of transmission). Hence, the decoder has to be aware of the FEC scheme to apply at each retransmission instant. Code-combining offers a higher flexibility with respect to soft-combining, since the length of the retransmitted packets can be altered to adapt to channel conditions. However, this requires more signaling data to be transmitted with respect to soft-combining.

In case the retransmitted packets carry some symbols identical to previously transmitted symbols and some code-symbols different from these, the identical code-symbols are combined using soft-combing as described above while the remaining code-symbols will be combined using code-combining. Here, the signaling requirements will be similar to code-combining.

In G. Benelli, “New mapping rules for combination of M-ary modulation and error-detecting codes in ARQ systems”, IEE Proceedings, Vol. 137, Pt. I, No. 4, August 1990, it has been shown that increasing the euclidean distances between signal constellation points more than linearly results in improved performance. This is particularly valid when identical data is to be repeated either by using multiple packet transmissions, or by repeating identical data within the same packet with different constellations.

The object underlying the present invention is to provide a data transmission method in an ARQ communication system, a transmitter and receiver thereof having an improved overall performance and robustness against transmission errors.

This object is solved by a method, a transmitter, a receiver and a communication system as defined by the independent claims. The invention can be seen as an efficient combination of Galois field symbol encoding, digital QPSK modulation and an efficient transmission symbol rearrangement over the several transmissions of the ARQ procedure. As a result, the interaction between the FEC coding and the QPSK modulation for the ARQ transmissions is optimized and also includes the beneficial effects of modulation symbol constellation rearrangement for additional ARQ retransmissions. As the retransmitted QPSK modulation symbols are modified, preferably by using different QPSK modulation schemes, a maximum uniform distribution of the accumulated distances between the symbols in the signal space is obtained. According to an alternate preferred embodiment, the modification of the GF symbols prior to QPSK modulation is obtained by GF arithmetic operation, for example, using a multiplication with a varying multiplicator according to the ARQ transmission scheme.

According to a further advantageous embodiment, the GF symbols are GF 4 symbols, which are obtained either directly from the encoding operation or after conversion of the encoder symbols prior to QPSK modulation.

A preferred embodiment of the transmitter comprises a plurality of mappers with different modulation schemes to generate the modified QPSK modulation symbols in accordance with a transmission pattern.

According to an alternate preferred embodiment, the transmitter comprises a multiplication unit for multiplying the GF symbols using a multiplicator, which varies with the transmission pattern.

According to a preferred embodiment of the receiver, same comprises a demapping unit with a plurality of demappers, employing different modulation schemes selected in accordance with the transmission pattern.

According to a further preferred embodiment, the receiver employs an FEC decoder, which performs decoding on the principle of euclidean distances in the signal space.

In the following the invention will be described in more detail referring to the accompanied drawings, which show:

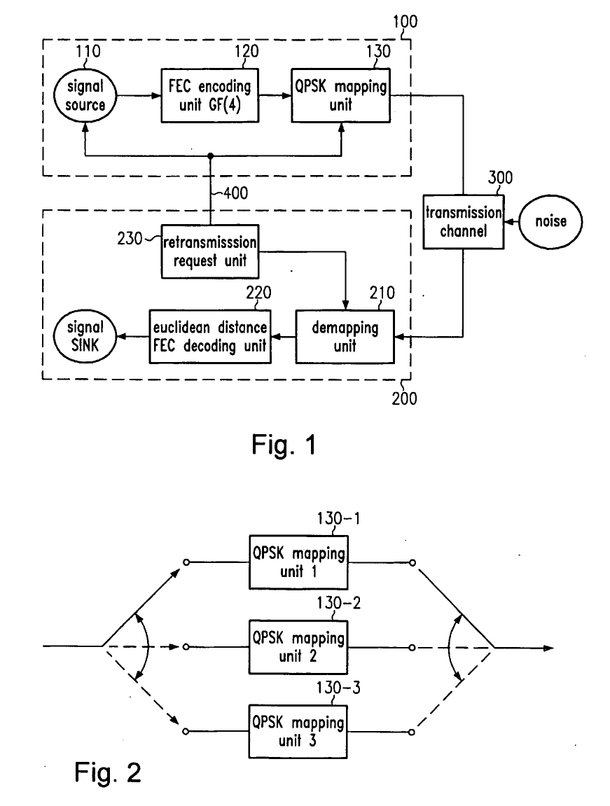

FIG. 1 a block diagram describing a communication system according to the present invention;

FIG. 2 a preferred embodiment for implementation of the QPSK mapper;

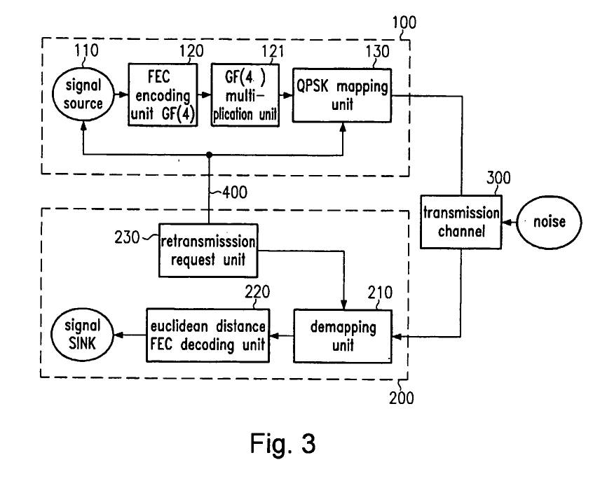

FIG. 3 a further preferred embodiment of the communication system according the present invention;

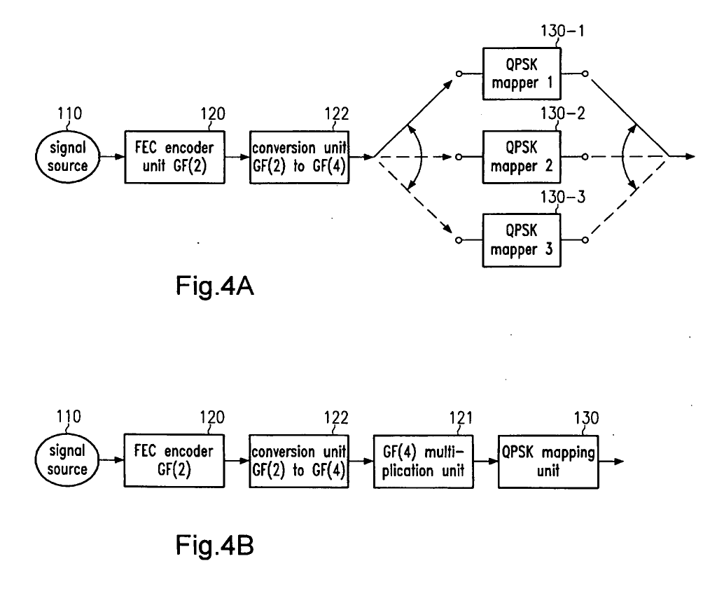

FIG. 4 a block diagram illustrating an alternate preferred embodiment for the transmitter;

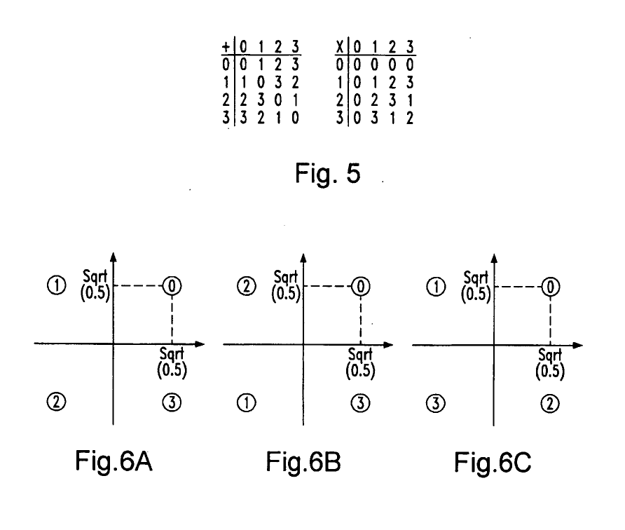

FIG. 5 examples for GF(4) arithmetics illustrating addition and multiplication operations; and

FIG. 6 examples for illustrating different modulation schemes in the signal plane.

FIG. 1 illustrates a block diagram of a communication system according to the present invention. The system comprises a transmitter 100, which communicates with a receiver 200 for transmitting data over a wired or wireless transmission channel 300. The transmission channel experiences noise resulting in a degradation of the performance and transmission errors. The receiver communicates by means of a feedback channel 400 with the transmitter, e.g. requests data and sends control signals for the transmission procedure.

In the transmitter 100, a signal source 110 outputs information bits with a certain data rate, which are subsequently encoded in an FEC encoder 120. The encoder generates symbols based on Galois field arithmetics. A Galois field is a mathematical field of finite elements. A field of four elements is commonly denoted as GF(4).

In a GF(4) field, addition and multiplication are well defined operations on the four elements. For convenience, before elements can be denoted as “0”, “1”, “2”, “3”. FIG. 5 gives tables for sample addition and multiplication operations.

The GF(4) symbols are input into a QPSK mapping unit 130 before transmission of the modulation symbols over the transmission channel 300.

QPSK is a digital modulation scheme employing 4 different signal constellation points, also known as modulation symbols, in the complex signal plane, as for example given in FIG. 6. Traditionally for binary transmission systems, these modulation symbols are each used to carry two bits. A commonly used sample mapping of bits onto modulation symbols is given in Table 1.

TABLE 1

| Bit | Modulation |
|---|---|
| sequence | symbol |
| 00 | 0 |
| 01 | 3 |
| 10 | 1 |
| 11 | 2 |

Euclidean distance decoding can show improved performance for a single transmission. This behaviour can be improved when several transmissions are launched using a variation of the distances of signal constellation points. To this end, there exist for example different modulation schemes for mapping the symbols onto constellation points. This sequence of modulation schemes forms a transmission pattern with the transmission number of a data packet as a parameter. Three different modulation schemes are illustrated in FIGS. 6A, B and C. In these, identical input symbols (“0”, “1”, “2”, “3”) are mapped onto different signal constellation points in a first, second, and third transmission respectively.

At the receiver 200, the data received over the transmission channel is first input into a de-mapping unit 210, which employs an analogous demodulation scheme to that used at the transmitter to modulate the GF(4) symbols. To this end, the receiver knows the QPSK demodulation scheme for the first and all further retransmissions. The transmission pattern is either pre-stored n a memory table or signalled, for example, following a negotiation routine between the transmitter and the receiver in an initialization phase. In this way, the receiver receives or notes the transmission number of the first transmission and all further retransmissions and selects the appropriate demodulation scheme. According to the preferred embodiment, the demapper provides the euclidean distances and neither the simple Hamming distances nor hard decisions as an output.

Subsequently, an FEC decoder 220 decodes the symbols demodulated by the demapping unit 210. According to the preferred embodiment, the decoder takes the euclidean distances into account and neither the simple Hamming distances nor the hard decisions.

The performance of a FEC code largely depends on the smallest Hamming distance dₘᵢₙ between codewords. For convolutional codes, this is mostly expressed by the free distance d_{free}.

For these smallest distances, a number of code generators have been found that optimise the performance. However these usually neglect the possibility of having different distances between codeword elements. For GF(4) elements a and b, the hamming distance is defined as

$$d ( a , b ) = \{ \begin{matrix}0 & for a = b \\ 1 & for a \neq b\end{matrix} \qquad ( 1 )$$

If a modulation scheme is used as in FIGS. 6A through 6C, it makes more sense to extend the definition into the signal space, such that squared euclidean distances are obtained:

$$\begin{matrix}{d}_{euclid} & 0 & 1 & 2 & 3 \\ 0 & 0 & 2 & 4 & 2 \\ 1 & 2 & 0 & 2 & 4 \\ 2 & 4 & 2 & 0 & 2 \\ 3 & 2 & 4 & 2 & 0\end{matrix} \qquad ( 2 )$$

For construction of a code that makes use of the modulation constellation, these distances should be take into account. This makes a euclidean distance decoder preferable in the receiver.

Rules and algorithms for finding good codes for a given distance profile are readily apparent for those skilled in the art without being further mentioned here and the invention includes the usage of such a found code optimised in terms of squared euclidean distances for a given modulation symbol constellation employed in the system.

As mentioned, above, the preferred embodiment of the present invention employs a FEC decoder based on euclidean distances. While this is preferred, it is nonetheless possible to employ simpler decoder structures, such as Hamming distance decoders, albeit at reduced performance.

Furthermore, the decoder 220 as it is depicted in FIG. 1 shall include means to combine the information obtained from several transmissions as stated in above. This can of course also be implemented in a separate entity within the receiver.

An example of a mapping of GF(4) code symbols onto QPSK modulation symbols is given in Table 2, in connection with either one of FIGS. 6A-6C.

For retransmissions of a packet changing the euclidean distances between modulation symbols improves the error decoding performance when soft-combining of the received data is performed in the receiver. Therefore, the mapping rules of GF(4) symbols onto QPSK modulation symbols can vary with the transmission number. When a retransmission is requested, the signal source has to be informed to retransmit data of the respective packet. Similarly the QPSK mapper and the demapper are notified of the modified mapping to be applied for the retransmission. The variation of the mappings is selected such that there is a maximum uniform distribution of accumulated euclidean distances between the symbols.

TABLE 2

| | QPSK | QPSK | QPSK |
|---|---|---|---|
| GF(4) | modulation | modulation | modulation |
| code | symbol | symbol | symbol |
| symbol | 1^{st} Tx | 2^{nd} Tx | 3^{rd} Tx |
| 0 | 0 | 0 | 0 |
| 3 | 3 | 2 | 1 |
| 1 | 1 | 1 | 3 |
| 2 | 2 | 3 | 2 |

It has been described above that by varying the euclidean distances between QPSK signals, the mapping of QPSK symbols is controlled according to the transmission pattern.

As illustrated in FIG. 2, a transmission symbol rearrangement in a first alternative, is obtained by employing a plurality, in this example, three different QPSK mapping units, which are selected in accordance with the transmission number as shown in Table 3. Each QPSK mapping entity 130-1 . . . 130-3 has its own distinct mapping rule, for example as in FIGS. 6A-6C. Which of these entities is used for the actual transmission is selected by the transmission pattern.

TABLE 3

| Transmission | QPSK |
|---|---|
| number | Mapping |
| 1, 4, 7, . . . | 1 |
| 2, 5, 8, . . . | 2 |
| 3, 6, 9, . . . | 3 |

As a second alternative, the mapping rules do not change and only one QPSK mapping entity is necessary. Instead, prior to mapping, a multiplication over GF(4) is applied by a multiplying unit 121 as illustrated in FIG. 3. The multiplier can be e.g. “1” for the first transmission, “2” for the second transmission, and “3” for the third transmission. In effect this also changes the euclidean distances over the retransmissions in a similar manner to a varied mapping of symbols. Besides the multiplying unit 121, all other elements remain unchanged as indicated with the same reference numerals of FIG. 1.

Usually the input and output data of the FEC encoder in current communication systems are of binary nature, i.e. elements of GF(2). In case the FEC input and output are elements of GF(2), a converter is required that converts two GF(2) symbols into one GF(4) symbol prior to applying different QPSK mappings as for example shown in FIG. 2 or prior to GF(4) multiplication unit as seen in FIG. 3. The result is illustrated in FIGS. 4A and 4B where the transmitter 100 includes a conversion unit 122. Table 4 gives a possible conversion scheme of GF(2) to GF(4) symbols.

TABLE 4

| Two | |
|---|---|
| GF(2) | GF(4) |
| symbols | symbol |
| 00 | 0 |
| 01 | 1 |
| 10 | 2 |
| 11 | 3 |

Alternatively, the FEC code can be a GF(2) to GF(4) code. Examples for this are given in W. E. Ryan, S. G. Wilson, “Two Classes of Convolutional Codes over GF(q) for q-ary Orthogonal Signaling”, IEEE Transactions on Communications, Vol. 39, No. 1, January 1991 and J. Chang, D. Hwang, M. Lin, “Some Extended Results on the Search for Good Convolutional Codes”, IEEE Transactions on Information Theory, Vol. 43, No. 5, September 1997.

1. A method for transmitting data from a transmitter to a receiver of an ARQ communication system comprising the steps of:
encoding data received from a signal source using a forward error correction (FEC) code to generate Galois field (GF) symbols;
mapping the GF symbols using quadrature phase shift keying (QPSK) as modulation scheme;
transmitting the QPSK modulation symbols to the receiver; and
retransmitting modified QPSK modulation symbols to the receiver.

2. The method according to claim 1, wherein the modified QPSK modulation symbols are obtained by modifying the GF symbols prior to QPSK modulation.

3. The method according to claim 2, wherein the modification is obtained by an arithmetic operation.

4. The method according to claim 3, wherein the arithmetic operation is a multiplication of the GF symbols with a varying multiplier.

5. The method according to claim 4, wherein the multiplier is related to a transmission number.

6. The method according to claim 1, wherein the modified QPSK modulation symbols are obtained by mapping the GF symbols using a different QPSK-modulation scheme.

7. The method according to claim 1, wherein the modification of the QPSK modulation symbols is selected such that a maximum uniform distribution of the accumulated euclidean distance between the symbols is obtained.

8. The method according to claim 1, wherein the GF symbols are GF(4) symbols, which are obtained either directly from the encoding operation or after conversion of GF(2) encoder symbols prior to QPSK modulation.

9. A transmitter for use in an ARQ communication system comprising:
a forward error correction (FEC) encoder for receiving data from a signal source and generating Galois field (GF) symbols;
a mapping unit for mapping the GF symbols using QPSK as modulation scheme; and
a transmission unit for transmitting QPSK modulation symbols and modified QPSK modulation symbols to a receiver.

10. The transmitter according to claim 9, wherein the mapping unit comprises a plurality of mappers with different modulation schemes to generate the modified QPSK modulation symbols in accordance with a transmission pattern.

11. The transmitter according to claims 9 or 10, further comprising a multiplication unit for multiplying the GF symbols using a multiplier, which is related to a transmission number.

12. The transmitter according to claim 9, further comprising a converter for converting encoded GF(2) symbols into GF(4) symbols.

13. A receiver in an ARQ communication system comprising:
a demapping unit for demapping received GF symbols modulated with QPSK as modulation scheme, said demapping unit being adapted to demodulate GF symbols, which have been modified in accordance with a transmission pattern; and
an FEC decoder for decoding and combining the output of said demapping unit.

14. The receiver according to claim 13, wherein the demapping unit comprises a plurality of demappers with different demodulation schemes selected in accordance with a transmission pattern.

15. The receiver according to claim 13 or 14, further comprising a multiplication unit for multiplying the GF symbols using a multiplier, which is related to a transmission number.

16. The receiver according to claim 13, wherein the FEC decoder performs error decoding on the principle of euclidean distances in the complex signal space.

17. A communication system comprising a transmitter according to claim 9 and a receiver comprising (i) a demapping unit for demapping received GF symbols modulated with QPSK as modulation scheme, said demapping unit being adapted to demodulate GF symbols, which have been modified in accordance with a transmission pattern, and (ii) an FEC decoder for decoding and combining the output of said demapping unit.
